(19) United States
(12) Patent Application Publication
(10) Pub. No.: US 2017/0371559 A1
(43) Pub. Date: Dec. 28, 2017

(54) Systems and Methods for Optimizing Media Read Times

(71) Applicant: SanDisk Technologies LLC, Plano, TX (US)

(72) Inventors: James M. Higgins, Chandler, AZ (US); James Fitzpatrick, Sudbury, MA (US)

(21) Appl. No.: 15/195,940

(22) Filed: Jun. 28, 2016

(51) Int. Cl. G06F 3/06

(52) U.S. Cl. CPC G06F 3/0611; G06F 3/0653; G06F 3/0673

(57) ABSTRACT

The various embodiments described herein include methods, systems, and devices for optimizing media read times. In one aspect, a method is performed at a device at a storage device with one or more processors and memory coupled to the one or more processors. The method includes: (i) predicting a read frequency for particular data; (ii) based on the predicted read frequency, determining one or more preferred storage locations within the memory; and (iii) storing the particular data in a preferred storage location of the one or more preferred storage locations.

### TECHNICAL FIELD

The disclosed embodiments relate generally to memory systems, including but not limited to, optimizing media read times within a non-volatile storage device.

### BACKGROUND

Semiconductor memory devices, including flash memory, typically utilize memory cells to store data as an electrical value, such as an electrical charge or voltage. A flash memory cell, for example, typically includes a single transistor with a floating gate that is used to store a charge representative of a data value. Flash memory is a non-volatile data storage device that can be electrically erased and reprogrammed. More generally, non-volatile memory (e.g., flash memory, as well as other types of non-volatile memory implemented using any of a variety of technologies) retains stored information even when not powered, as opposed to volatile memory, which requires power to maintain the stored information. Increases in storage density have been facilitated in various ways, including increasing the density of memory cells on a chip enabled by manufacturing developments, and transitioning from single-level flash memory cells to multi-level flash memory cells, so that two or more bits can be stored by each flash memory cell.

Read response times are increasingly important to storage consumers. In some instances, such as when read operations are much more frequent than write operations, read response times are a primary performance metric. The read response time varies from memory cell to memory cell. It is therefore important to optimize read response times to enhance device performance.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to optimize read times to enhance performance a non-volatile storage device. In one aspect, based on a predicted read frequency for particular data, one or more preferred storage locations within the memory are determined and the particular data is stored in one of the one or more preferred storage locations.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIGS. 1A-1B are block diagrams illustrating implementations of a data storage system, in accordance with some embodiments.

FIGS. 2A-2B are block diagrams illustrating implementations of a management module, in accordance with some embodiments.

FIG. 3 is a block diagram illustrating a set of read disturb counters and corresponding non-volatile memory block zones.

FIG. 4 is a block diagram illustrating a read tracking table and corresponding logical address spaces, in accordance with some embodiments.

FIGS. 5A-5B illustrate exemplar read response tables, in accordance with some embodiments.

FIGS. 5C-5D illustrate exemplar data organization within implementations of a write buffer, in accordance with some embodiments.

FIG. 6 is a conceptual diagram of a read prediction engine, in accordance with some embodiments.

FIGS. 7A-7C illustrate a flowchart representation of a read optimization method, in accordance with some embodiments.

FIG. 8 illustrates a flowchart representation of another read optimization method, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to optimize read times to enhance performance of a non-volatile storage device. Some implementations include systems, methods and/or devices to determine, based on a predicted read frequency for particular data, one or more preferred storage locations within the memory, and store the particular data in one of the one or more preferred storage locations.

(A1) In one aspect, some implementations include a method performed at a storage device with one or more processors and memory coupled to the one or more processors. The method includes: (1) predicting a read frequency (sometimes called a read temperature) for particular data; (2) based on the predicted read frequency, determining one or more preferred storage locations within the memory; and (3) storing the particular data in a preferred storage location of the one or more preferred storage locations.

(A2) In some implementations of the method of A1, predicting the read frequency for the particular data includes predicting the read frequency for the particular data based on an amount of read disturbs associated with the particular data.

(A3) In some implementations of the method of any one of A1-A2, the method further includes obtaining the particular data from a host system; where predicting the read frequency for the particular data includes obtaining read frequency information from the host system.

(A4) In some implementations of the method of any one of A1-A3, the method further includes tracking a number of read operations corresponding to a particular region of a plurality of regions in a logical address space of a host; where the particular data corresponds to a particular region of the plurality of regions; and where predicting the read frequency for the particular data comprises predicting the read frequency for the particular data based on the tracked number of read operations.

(A5) In some implementations of the method of any one of A1-A4, the predicted read frequency indicates that the particular data is hot read data; and the one or more preferred storage locations include storage locations denoted as having a fast read response.

(A6) In some implementations of the method of any one of A1-A5, the storage device further includes a write buffer, and storing the particular data in the preferred storage location comprises: (1) holding the particular data at a location within the write buffer corresponding to the preferred storage location; and (2) transferring the particular data from the write buffer to the preferred storage location.

(A7) In some implementations of the method of any one of A1-A6, the memory includes a plurality of memory groups and the method further includes: (1) obtaining a respective read response parameter for each memory group of the plurality of memory groups; (2) mapping the predicted read frequency to a particular read response parameter value; and (3) comparing the particular read response parameter value to the respective read response parameter for a particular memory group, the particular memory group including at least one preferred storage location of the one or more preferred storage locations; where determining the one or more preferred storage locations within the memory includes determining the at least one preferred storage location based on the comparison of the particular read response parameter value to the read response parameter for the particular memory group.

(A8) In some implementations of the method of A7, the read response parameter is based on at least one of: (1) a read latency for the particular memory group (e.g., an average latency or peak latency); (2) an error rate for the particular memory group (e.g., an error rate for a particular page, die, or block); and (3) a word line corresponding to the particular memory group (e.g., word line 0).

(A9) In some implementations of the method of any one of A7-A8, each memory group of the plurality of memory groups corresponds to a particular memory page type (e.g., upper, middle, lower pages).

(A10) In some implementations of the method of any one of A1-A9, the method further includes: (1) obtaining second data; (2) predicting a read frequency for the second data; (3) based on the predicted read frequency for the second data, determining one or more second preferred storage locations within the memory; and (4) based on one or more write conditions, storing the second data in a location in memory other than the one or more second preferred storage locations.

(A11) In some implementations of the method of any one of A1-A10, the method further includes: (1) obtaining read frequency information corresponding to the particular data; (2) predicting a new read frequency for the particular data based on the obtained read frequency information; (3) determining one or more new preferred storage locations within the memory based on the new read frequency prediction, where the one or more new preferred storage locations are distinct from the one or more preferred storage locations; and (4) transferring the particular data to a new preferred storage location of the one or more new preferred storage locations.

(A12) In some implementations of the method of any one of A1-A11, the memory comprises a plurality of non-volatile memory devices (e.g., flash memory devices).

(A13) In some implementations of the method of any one of A11-A12, the memory comprises one or more three-dimensional (3D) memory devices, and the storage device includes circuitry associated with operation of memory elements in one or more 3D memory devices.

(A14) In some implementations of the method of A13, the circuitry and one or more memory elements in a respective 3D memory device of the one or more 3D memory devices are on the same substrate.

In another aspect, some implementations include a storage system including memory and a controller coupled to the memory. In some implementations, the controller is configured to perform any of the methods described herein (e.g., A1-A14 described above).

In yet another aspect, some implementations include a non-transitory computer-readable storage medium storing one or more programs for execution by one or more processors of a storage device, the one or more programs including instructions for performing any of the methods described herein (e.g., A1-A14 described above).

In yet another aspect, some implementations include a storage system with the means to perform any of the methods described herein (e.g., A1-A14 described above).

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

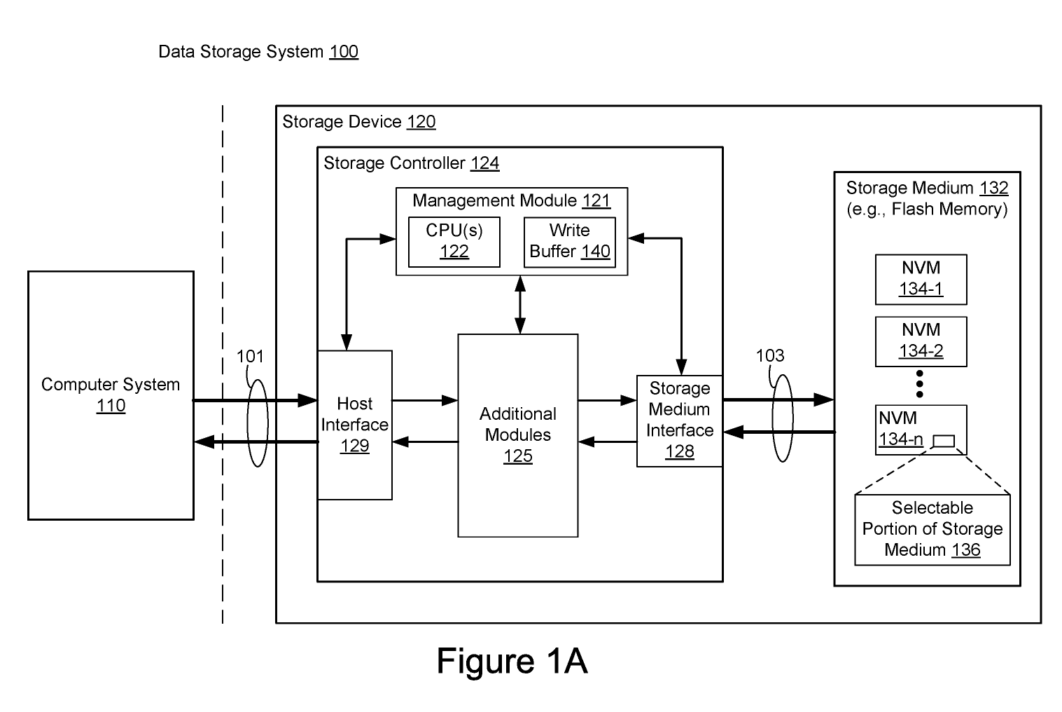

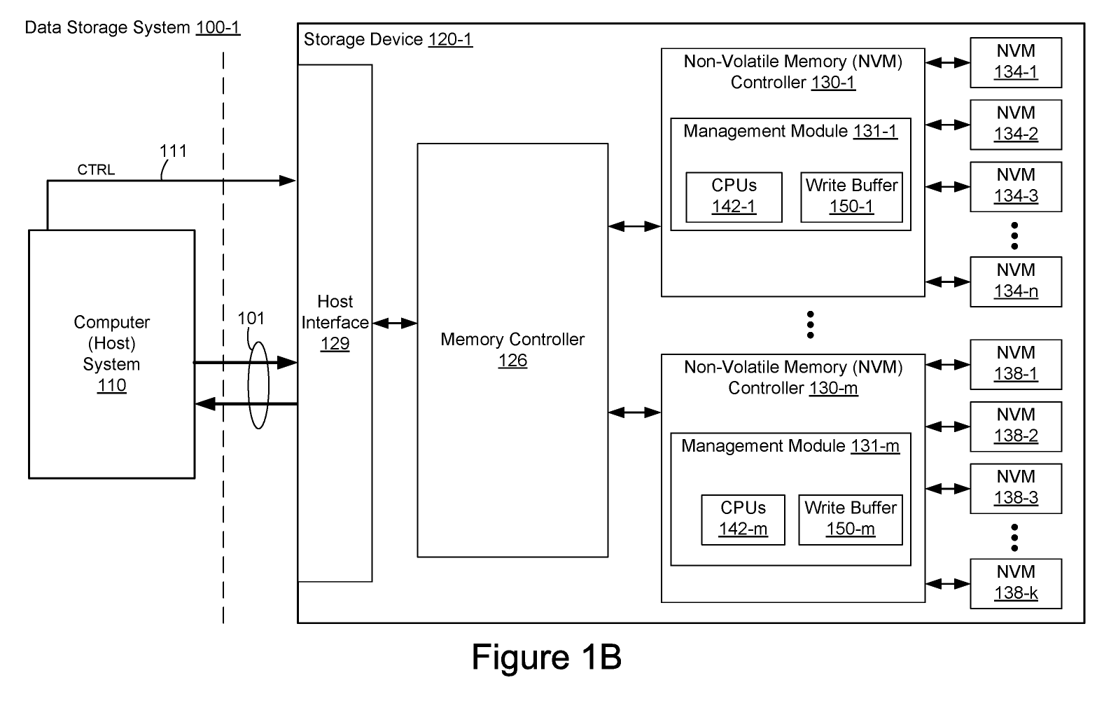

FIG. 1A is a block diagram illustrating an implementation of a data storage system 100, in accordance with some embodiments. While some example features are illustrated, various other features have not been illustrated for the sake of brevity and so as not to obscure pertinent aspects of the example embodiments disclosed herein. To that end, as a non-limiting example, data storage system 100 includes a storage device 120 (also sometimes called an information storage device, or a data storage device, or a memory device), which includes a storage controller 124 and a storage medium 132, and is used in conjunction with or includes a computer system 110 (e.g., a host system or a host computer). In some embodiments, storage medium 132 is a single flash memory device while in other embodiments storage medium 132 includes a plurality of flash memory devices. In some embodiments, storage medium 132 is NAND-type flash memory or NOR-type flash memory. In some embodiments, storage medium 132 includes one or more three-dimensional (3D) memory devices. Further, in some embodiments, storage controller 124 is a solid-state drive (SSD) controller. However, other types of storage media may be included in accordance with aspects of a wide variety of embodiments (e.g., PCRAM, ReRAM, STT-RAM, etc.). In some embodiments, a flash memory device includes one or more flash memory die, one or more flash memory packages, one or more flash memory channels or the like. In some embodiments, data storage system 100 includes a plurality of storage devices 120.

Computer system 110 is coupled to storage controller 124 through data connections 101. However, in some embodiments computer system 110 includes storage controller 124, or a portion of storage controller 124, as a component and/or as a subsystem. For example, in some embodiments, some or all of the functionality of storage controller 124 is implemented by software executed on computer system 110. Computer system 110 may be any suitable computer device, such as a computer, a laptop computer, a tablet device, a netbook, an internet kiosk, a personal digital assistant, a mobile phone, a smart phone, a gaming device, a computer server, or any other computing device. Computer system 110 is sometimes called a host, host system, client, or client system. In some embodiments, computer system 110 is a server system, such as a server system in a data center. In some embodiments, computer system 110 includes one or more processors, one or more types of memory, a display and/or other user interface components such as a keyboard, a touch-screen display, a mouse, a track-pad, a digital camera, and/or any number of supplemental I/O devices to add functionality to computer system 110. In some embodiments, computer system 110 does not have a display and other user interface components.

Storage medium 132 is coupled to storage controller 124 through connections 103. Connections 103 are sometimes called data connections, but typically convey commands in addition to data, and optionally convey metadata, error correction information and/or other information in addition to data values to be stored in storage medium 132 and data values read from storage medium 132. In some embodiments, storage controller 124 and storage medium 132 are included in the same device (i.e., an integrated device) as components thereof. Furthermore, in some embodiments, storage controller 124 and storage medium 132 are embedded in a host device (e.g., computer system 110), such as a mobile device, tablet, other computer or computer controlled device, and the methods described herein are performed, at least in part, by the embedded storage controller. Storage medium 132 may include any number (i.e., one or more) of memory devices (e.g., NVM 134-1, NVM 134-2 through NVM 134-n) including, without limitation, persistent memory or non-volatile semiconductor memory devices, such as flash memory device(s). For example, flash memory device(s) can be configured for enterprise storage suitable for applications such as cloud computing, for database applications, primary and/or secondary storage, or for caching data stored (or to be stored) in secondary storage, such as hard disk drives. Additionally and/or alternatively, flash memory device(s) can also be configured for relatively smaller-scale applications such as personal flash drives or hard-disk replacements for personal, laptop, and tablet computers.

Memory devices (e.g., NVM 134-1, NVM 134-2, etc.) of storage medium 132 include addressable and individually selectable blocks, such as selectable portion of storage medium 136 (also referred to herein as selected portion 136). In some embodiments, the individually selectable blocks (sometimes called erase blocks) are the minimum size erasable units in a flash memory device. In other words, each block contains the minimum number of memory cells that can be erased simultaneously. In some embodiments, each block is further divided into a plurality of pages and/or word lines. In some embodiments, each page or word line is an instance of the smallest individually accessible (readable) portion in a block. In some embodiments (e.g., using some types of flash memory), the smallest individually accessible unit of a data set, however, is a sector, which is a subunit of a page. That is, a block includes a plurality of pages, each page contains a plurality of sectors, and each sector is the minimum unit of data for writing data to or reading data from the flash memory device.

In some embodiments, storage controller 124 includes a management module 121, a host interface 129, a storage medium I/O interface 128, and, optionally, one or more additional module(s) 125, such as an error correction module and/or a garbage collection module. Storage controller 124 may include various additional features that have not been illustrated for the sake of brevity and so as not to obscure pertinent features of the example embodiments disclosed herein, and a different arrangement of features may be possible. Host interface 129 provides an interface to computer system 110 through data connections 101. Similarly, storage medium interface 128 (sometimes called storage medium I/O 128) provides an interface to storage medium 132 through connections 103. In some embodiments, storage medium I/O 128 includes read and write circuitry, including circuitry capable of providing reading signals to storage medium 132 (e.g., reading threshold voltages for NAND-type flash memory).

In some embodiments, management module 121 includes one or more processing units 122 (sometimes herein called CPUs, processors, or hardware processors, and sometimes implemented using microprocessors, microcontrollers, or the like) configured to execute instructions in one or more programs (e.g., in management module 121). In some embodiments, the one or more processing units 122 are shared by one or more components within, and in some cases, beyond the function of storage controller 124. Management module 121 is coupled to host interface 129, additional module(s) 125, and storage medium I/O 128 in order to coordinate the operation of these components. In some embodiments, one or more modules of management module 121 are implemented in a management module of computer system 110 (not shown). In some embodiments, one or more processors of computer system 110 (not shown) are configured to execute instructions in one or more programs. In some embodiments, a management module within computer system 110 is coupled to storage device 120 in order to manage the operation of storage device 120.

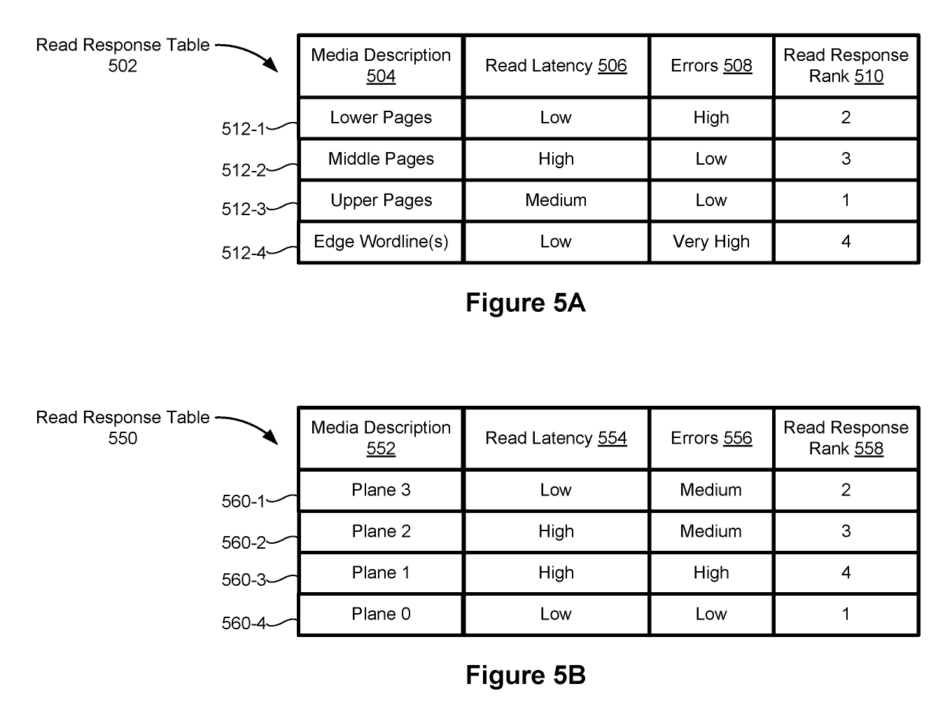

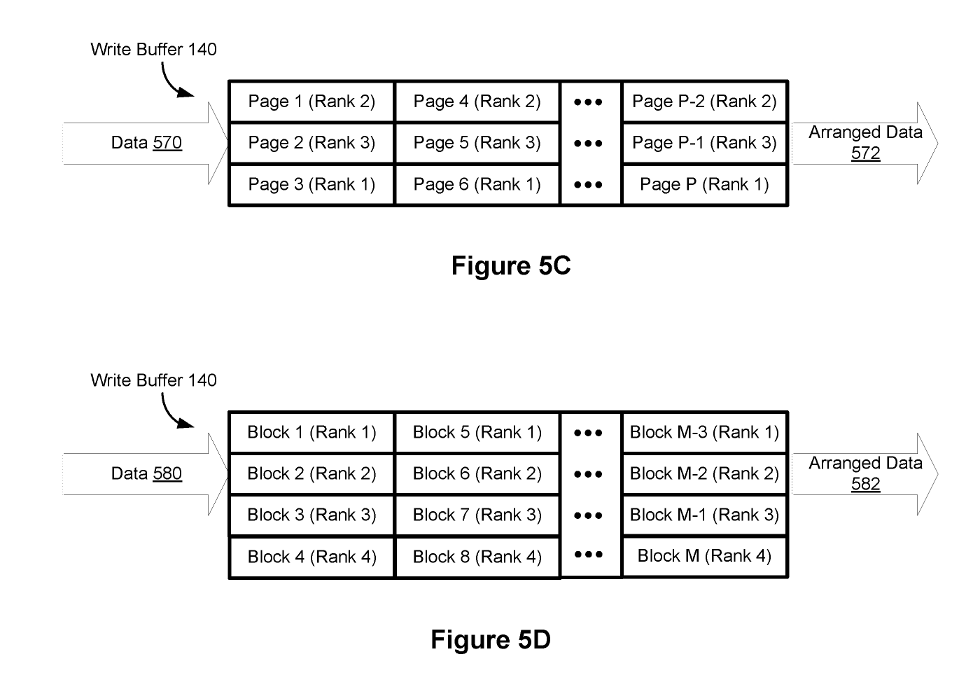

In some embodiments, management module 121 includes write buffer 140. In some embodiments, write buffer 140 comprises volatile memory, such as dynamic random access memory (DRAM). In some other embodiments, write buffer 140 comprises non-volatile memory, such as non-volatile random access memory (NVRAM). Write buffer 140 holds (e.g., temporarily stores) data received by management module 121 prior to it being written to storage medium 132. In some embodiments, write buffer 140 holds host data, control data, metadata, and the like. In some embodiments, write buffer 140 is used to arrange data into a particular order so that it can be written to particular memory cells within storage medium 132. Additional details regarding the operation of write buffer 140 are described below with respect to FIGS. 5C-5D.

Additional module(s) 125 are coupled to storage medium I/0 128, host interface 129, and management module 121-1. As an example, additional module(s) 125 optionally include an error control module to limit the number of uncorrectable errors inadvertently introduced into data during writes to memory or reads from memory. In some embodiments, additional module(s) 125 are executed in software by the one or more processing units 122 of management module 121, and, in other embodiments, additional module(s) 125 are implemented in whole or in part using special purpose circuitry (e.g., to perform data encoding and decoding functions). In some embodiments, additional module(s) 125 are implemented in whole or in part by software executed on computer system 110.

In some embodiments, an error control module, included in additional module(s) 125, includes an encoder and a decoder. In some embodiments, the encoder encodes data by applying an error-correcting code (ECC) to produce a codeword, which is subsequently stored in NVM devices 134. When encoded data (e.g., one or more codewords) is read from NVM devices 134, the decoder applies a decoding process to the encoded data to recover the data, and to correct errors in the recovered data within the error correcting capability of the error-correcting code. Those skilled in the art will appreciate that various error-correcting codes have different error detection and correction capacities, and that particular codes are selected for various applications for reasons beyond the scope of this disclosure. As such, an exhaustive review of the various types of error-correcting codes is not provided herein. Moreover, those skilled in the art will appreciate that each type or family of error-correcting codes may have encoding and decoding algorithms that are particular to the type or family of error-correcting codes. On the other hand, some algorithms may be utilized at least to some extent in the decoding of a number of different types or families of error-correcting codes. As such, for the sake of brevity, an exhaustive description of the various types of encoding and decoding algorithms generally available and known to those skilled in the art is not provided herein.

In some embodiments, during a write operation, host interface 129 receives data to be stored in NVM devices 134 from computer system 110. The data received by host interface 129 is made available to an encoder (e.g., in additional module(s) 125), which encodes the data to produce one or more codewords. The one or more codewords are made available to storage medium interface 128, which transfers the one or more codewords to storage medium 132 in a manner dependent on the type of storage medium being utilized.

In some embodiments, a read operation is initiated when computer system (host) 110 sends one or more host read commands (e.g., via data connections 101, or alternatively a separate control line or bus) to storage controller 124 requesting data from NVM devices 134. Storage controller 124 (e.g., management module 121) sends one or more read access commands to NVM devices 134, via storage medium interface 128, to obtain raw read data in accordance with memory locations (addresses) specified by the one or more host read commands. Storage medium interface 128 provides the raw read data (e.g., comprising one or more codewords) to a decoder (e.g., in additional module(s) 125). If the decoding is successful, the decoded data is provided to host interface 129, where the decoded data is made available to computer system 110. In some embodiments, if the decoding is not successful, storage controller 124 may resort to a number of remedial actions or provide an indication of an irresolvable error condition.

As explained above, a storage medium (e.g., storage medium 132) is divided into a number of addressable and individually selectable blocks and each block is optionally (but typically) further divided into a plurality of pages and/or word lines and/or sectors. While erasure of a storage medium is performed on a block basis, in many embodiments, reading and programming of the storage medium is performed on a smaller subunit of a block (e.g., on a page basis, word line basis, or sector basis). In some embodiments, the smaller subunit of a block consists of multiple memory cells (e.g., a plurality of single-level cells and/or multi-level cells). In some embodiments, programming is performed on an entire page. In some embodiments, a multi-level cell (MLC) NAND flash is utilized. MLC NAND has four possible states per cell, yielding two bits of information per cell. Further, in some embodiments, an MLC NAND has two page types: (1) a lower page (sometimes called fast page), and (2) an upper page (sometimes called slow page). In some embodiments, a triple-level cell (TLC) NAND flash is utilized. TLC NAND has eight possible states per cell, yielding three bits of information per cell. Although the description herein uses TLC, MLC, and SLC as examples, those skilled in the art will appreciate that the embodiments described herein may be extended to memory cells that have more than eight possible states per cell, yielding more than three bits of information per cell. In some embodiments, the encoding format of the storage media (i.e., TLC, MLC, or SLC and/or a chosen data redundancy mechanism or ECC code) is a choice made when data is received at the storage device or when written to the storage medium.

As an example, in some embodiments, if data is written to a storage medium in pages, but the storage medium is erased in blocks, pages in the storage medium may contain invalid (e.g., stale) data, but those pages cannot be overwritten until the whole block containing those pages is erased. In order to write to the pages with invalid data, the pages (if any) with valid data in that block are read and re-written to a new block and the old block is erased (or put on a queue for erasing). This process is typically called garbage collection. After garbage collection, the new block contains the pages with valid data and may have free pages that are available for new data to be written, and the old block can be erased so as to be available for new data to be written. Since flash memory can only be programmed and erased a limited number of times, the efficiency of the algorithm used to pick the next block(s) to re-write and erase has an impact on the lifetime and reliability of flash-based storage systems.

Write amplification is a phenomenon where the actual amount of physical data written to a storage medium (e.g., NVM devices 134) is a multiple of the logical amount of data written by a host (e.g., computer system 110) to the storage medium. As discussed above, when a block of storage medium must be erased before it can be re-written, the garbage collection process to perform these operations results in re-writing data one or more times. This multiplying effect increases the number of writes required over the life of a storage medium, which shortens the time it can reliably operate. The formula to calculate the write amplification of a storage system is given by an equation, such as Equation 1 below.

$$write amplification = \frac{amount of data written to a storage medium}{amount of data written by a host} \qquad ( Equation 1 )$$

In some instances, one of the goals of a flash memory based data storage system architecture is to reduce write amplification as much as possible so that available endurance is used to meet storage medium reliability and warranty specifications. Higher system endurance also results in lower cost as the storage system may need less over-provisioning. By reducing write amplification, the endurance of the storage medium is increased and the overall cost of the storage system is decreased. Generally, garbage collection is performed on erase blocks with the fewest number of valid pages for best performance and best write amplification.

Flash memory devices utilize memory cells to store data as electrical values, such as electrical charges or voltages. Each flash memory cell typically includes a single transistor with a floating gate that is used to store a charge, which modifies the threshold voltage of the transistor (i.e., the voltage needed to turn the transistor on). The magnitude of the charge, and the corresponding threshold voltage the charge creates, is used to represent one or more data values. In some embodiments, during a read operation, a reading threshold voltage is applied to the control gate of the transistor and the resulting sensed current or voltage is mapped to a data value.

The terms “cell voltage” and “memory cell voltage,” in the context of flash memory cells, means the threshold voltage of the memory cell, which is the minimum voltage that needs to be applied to the gate of the memory cell's transistor in order for the transistor to conduct current. Similarly, reading threshold voltages (sometimes also called reading signals and reading voltages) applied to a flash memory cells are gate voltages applied to the gates of the flash memory cells to determine whether the memory cells conduct current at that gate voltage. In some embodiments, when a flash memory cell's transistor conducts current at a given reading threshold voltage, indicating that the cell voltage is less than the reading threshold voltage, the raw data value for that read operation is a “1” and otherwise the raw data value is a “0.”

Although FIG. 1A shows particular blocks of data storage system 100, FIG. 1A is intended more as a functional description of the various features which may be present in data storage system than as a structural schematic of the embodiments described herein. In practice, and as recognized by those of ordinary skill in the art, items shown separately could be combined and some items could be separated. In some embodiments, storage device 120 includes various additional features that have not been illustrated, such as any of the features described below with respect to FIG. 1B.

FIG. 1B is a block diagram illustrating an implementation of a data storage system 100-1, in accordance with some embodiments. While some exemplary features are illustrated, various other features have not been illustrated for the sake of brevity and so as not to obscure more pertinent aspects of the example implementations disclosed herein. To that end, as a non-limiting example, data storage system 100-1 includes storage device 120-1, which includes host interface 129, memory controller 126, one or more non-volatile memory controllers 130, and non-volatile memory devices (NVM 134 and 138), and is used in conjunction with computer system 110. In some embodiments, storage device 120-1 includes various additional features that have not been illustrated, such as any of the features described above with respect to FIG. 1A. Those of ordinary skill in the art will recognize that different arrangements of features are also possible.

Host interface 129 provides an interface to computer system 110 through data connections 101. Memory controller 126 is coupled to host interface 129 and non-volatile memory controllers 130. In some implementations, during a write operation, memory controller 126 receives data from computer system 110 through host interface 129 and during a read operation, memory controller 126 sends data to computer system 110 through host interface 129. Further, host interface 129 provides additional data, signals, voltages, and/or other information needed (or preferred) for communication between memory controller 126 and computer system 110. In some embodiments, memory controller 126 and host interface 129 use a defined interface standard for communication, such as double data rate type three synchronous dynamic random access memory (DDR3). In some embodiments, memory controller 126 and non-volatile memory controllers 130 use a defined interface standard for communication, such as serial advance technology attachment (SATA). In some other implementations, the device interface used by memory controller 126 to communicate with non-volatile memory controllers 130 is SAS (serial attached SCSI), or other storage interface. In some implementations, memory controller 126 includes one or more processing units (sometimes herein called CPUs, processors, or hardware processors, and sometimes implemented using microprocessors, microcontrollers, or the like) configured to execute instructions in one or more programs (e.g., in memory controller 126). In some implementations, the one or more processors are shared by one or more components within, and in some instances, beyond the function of memory controller 126.

In some embodiments, the non-volatile memory controllers 130 include management modules 131. In some embodiments, a particular management module 131 (e.g., management module 131-1) comprises management module 121 illustrated in FIG. 1A. In some embodiments, the management modules 131 each include one or more processing units 142 (sometimes herein called CPUs, processors, or hardware processors, and sometimes implemented using microprocessors, microcontrollers, or the like) configured to execute instructions in one or more programs (e.g., in management module 131) and a write buffer 150 for holding and/or arranging data to be written to non-volatile memory (e.g., NVM 134-1).

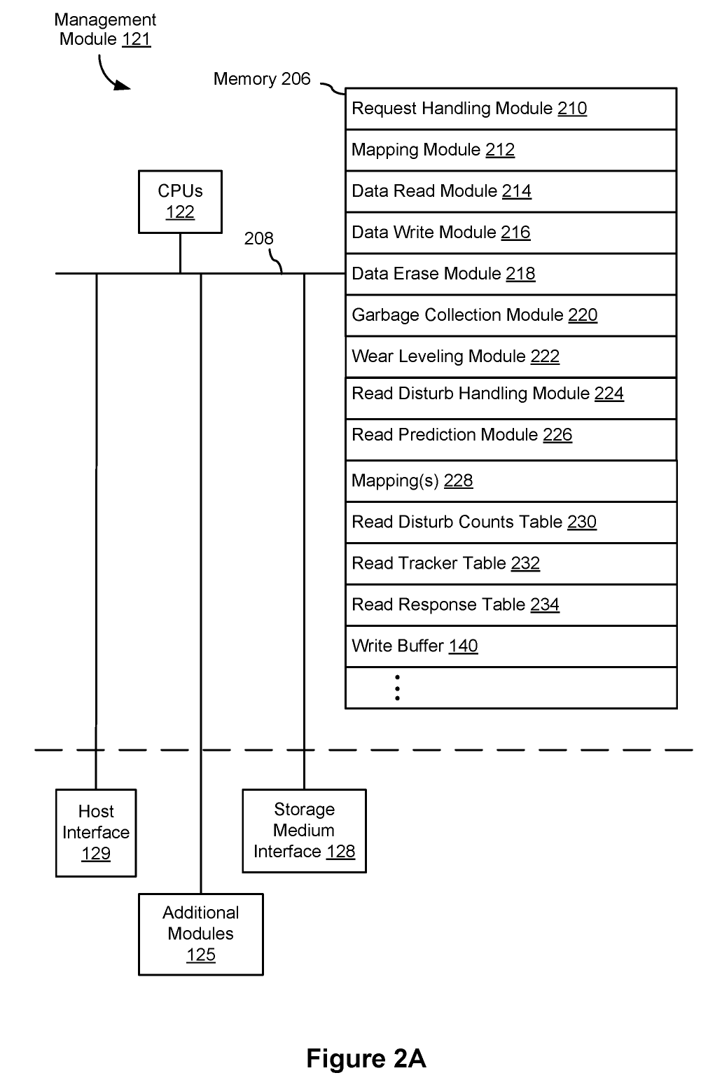

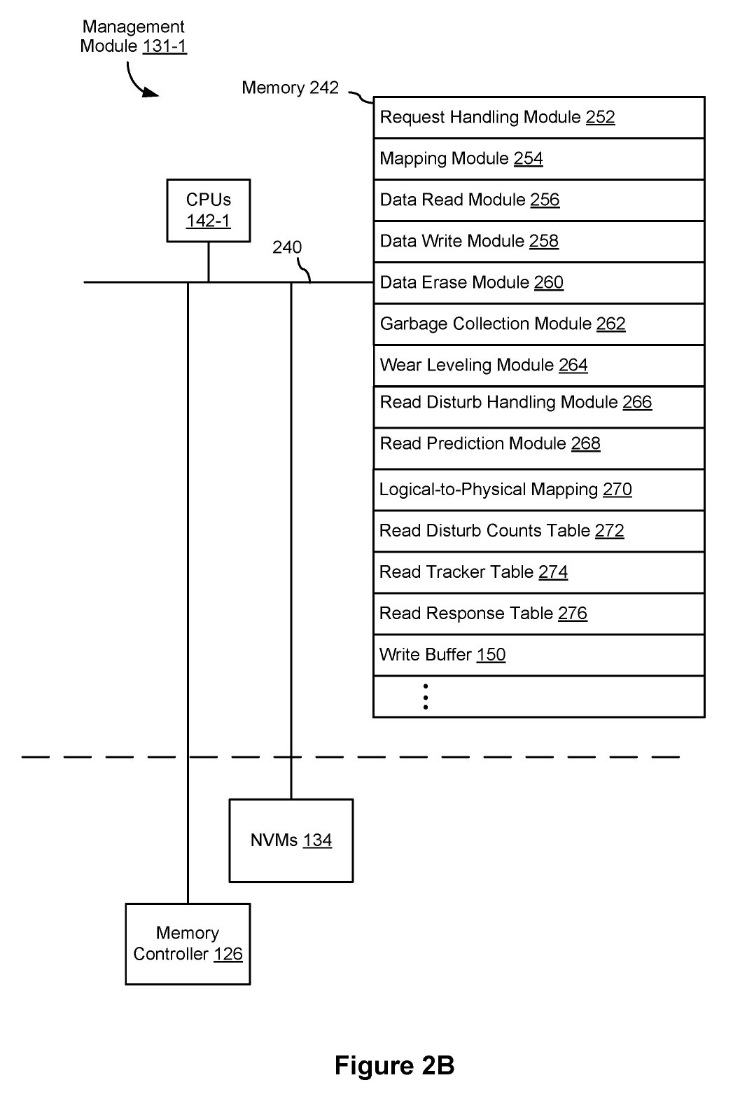

In some embodiments, memory controller 126 and NVM controllers 130 work in conjunction to perform any of the operations described herein with respect to storage device 120. In some embodiments, management modules 131 work either independently or in conjunction to perform any of the operations described herein with respect to management module 121. In some embodiments, management module 131-1 receives data from memory controller 126 (e.g., host data) and transfers the data to NVM memory (e.g., NVM 134-1). In some embodiments or circumstances, management module 131-1 receives data from another management module 131 (e.g., management module 131-m) and transfers the data to NVM (e.g., NVM 134-n). Additional details regarding the operation of management modules 121 and 131 are described below with respect to FIGS. 2A-2B.

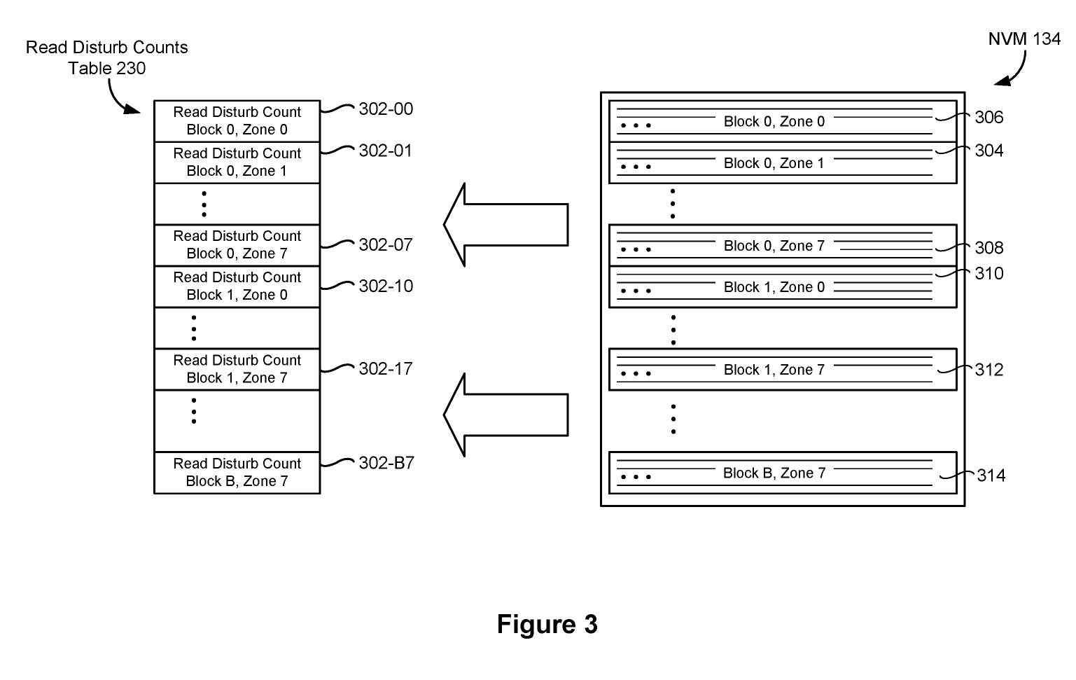

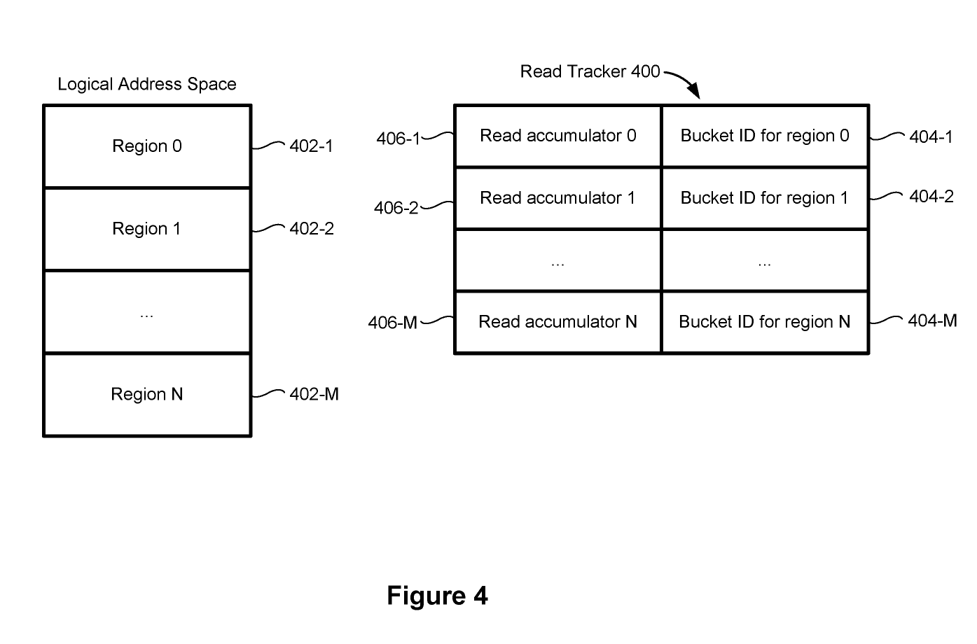

FIG. 2A is a block diagram illustrating an implementation of management module 121, in accordance with some embodiments. Management module 121 includes: one or more processing units 122 for executing modules, programs and/or instructions stored in memory 206 and thereby performing processing operations, memory 206 (sometimes herein called controller memory), and one or more communication buses 208 for interconnecting these components. Communication buses 208 optionally include circuitry (sometimes called a chipset) that interconnects and controls communications between system components. In some embodiments management module 121 is coupled to a memory controller by communication buses 208, and is coupled to non-volatile memory devices 134 (e.g., non-volatile memory devices 134-1 through 134-n) by communication buses 208 and storage medium interface 128. Memory 206 includes high-speed random access memory, such as DRAM, SRAM, DDR RAM or other random access solid state memory devices, and may include non-volatile memory, such as one or more magnetic disk storage devices, optical disk storage devices, flash memory devices, non-volatile RAM (NVRAM), or other non-volatile solid state storage devices. Memory 206 optionally includes one or more storage devices remotely located from processor(s) 122. In some embodiments, memory 206, or alternately the non-volatile memory device(s) within memory 206, comprises a non-transitory computer-readable storage medium. In some embodiments, memory 206, or the computer-readable storage medium of memory 206 stores the following programs, modules, and data structures, or a subset or superset thereof:
request handling module 210 for receiving input/output (I/O) requests from a host (e.g., write requests and/or read requests);
mapping module 212 for mapping logical addresses to physical addresses (e.g., using logical-to-physical mapping 228) and vice versa;
data read module 214 data for reading data, or causing data to be read, from storage device 120 (e.g., from storage medium 132);
data write module 216 writing data, or causing data to be written, to storage device 120 (e.g., to storage medium 132);
data erase module 218 for erasing data, or causing data to be erased, from storage device 120 (e.g., from storage medium 132);
garbage collection module 220 for performing a garbage collection process on one or more memory portions (e.g., selectable portion 136) of storage device 120 (e.g., one or more memory portions of storage medium 132);
wear leveling module 222 for determining memory portions (i.e., pages or blocks) of storage device 120 (e.g., storage medium 132) for storing data so as to evenly wear the memory portions of storage device 120 (e.g., storage medium 132);
read disturb handling module 224 for one or more of: maintaining a running count of read disturbs in each zone of a plurality of non-volatile memory blocks, performing a validation operation when any read disturb count satisfies predefined threshold criteria, and initiating a data refresh when the validation operation is unsuccessful;
read prediction module 226 for predicting a read frequency for data to be stored in storage device 120 (e.g., in storage medium 132);
mappings 228 storing one or more of: a logical-to-physical map (used, for example, by mapping module 212) that maps logical addresses recognized by the host (e.g., computer system 110) to physical addresses of storage device 120 (e.g., NVM devices 134), and a physical-to-logical mapping that maps physical addresses to logical addresses;
read disturb counts table 230, for storing the read disturb counts maintained by read disturb handling module 224 (e.g., to be used in predicting future read frequency for data), as discussed with reference to FIG. 3 below;
read tracking table 232 for tracking number of reads for logical address spaces and/or physical address spaces (e.g., to be used in predicting future read frequency for data), as discussed with reference to FIG. 4 below;
read response table 234 for storing absolute and/or relative read response times for portions (e.g., pages, layers, planes, and/or blocks) of a storage medium (e.g., storage medium 132), as discussed with reference to FIGS. 5A-5B below; and
write buffer 140 for holding and/or organizing data to be written to a storage medium (e.g., storage medium 132), as discussed with reference to FIGS. 5C-5D below.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the non-transitory computer-readable storage medium of memory 206, provide instructions for implementing at least some of the methods, or portions of the methods, described herein. In some embodiments, some or all of these modules may be implemented with specialized hardware circuits that subsume part or all of the module functionality.

Although FIG. 2A shows a management module 121, FIG. 2A is intended more as functional description of the various features which may be present in a management module than as a structural schematic of the embodiments described herein. In practice, and as recognized by those of ordinary skill in the art, items shown separately could be combined and some items could be separated. For example, in some embodiments, data erase module 218 and garbage collection module 220 are combined into a single module. In some embodiments, one or more of the operations and/or modules of management module 121 may instead be performed and/or implemented by other modules and/or computer system 110.

FIG. 2B is a block diagram illustrating an implementation of a management module 131 (e.g., management module 131-1), in accordance with some embodiments. Management module 131 includes: one or more processing units 142 for executing modules, programs and/or instructions stored in memory 242 and thereby performing processing operations, memory 242 (sometimes herein called controller memory), and one or more communication buses 240 for interconnecting these components. Communication buses 240 optionally include circuitry (sometimes called a chipset) that interconnects and controls communications between system components. In some embodiments management module 131 is coupled to a memory controller (e.g., memory controller 126) by communication buses 240, and is coupled to non-volatile memory devices 134 (e.g., non-volatile memory devices 134-1 through 134-n) and/or non-volatile memory devices 138 (e.g., non-volatile memory devices 138-1 through 138-k) by communication buses 240. Memory 242 includes high-speed random access memory, such as DRAM, SRAM, DDR RAM or other random access solid state memory devices, and may include non-volatile memory, such as one or more magnetic disk storage devices, optical disk storage devices, flash memory devices, non-volatile RAM (NVRAM), or other non-volatile solid state storage devices. Memory 242 optionally includes one or more storage devices remotely located from processor(s) 142. In some embodiments, memory 242, or alternately the non-volatile memory device(s) within memory 242, comprises a non-transitory computer-readable storage medium. In some embodiments, memory 242, or the computer-readable storage medium of memory 242 stores the following programs, modules, and data structures, or a subset or superset thereof:
request handling module 252 for receiving input/output (I/O) requests from a host (e.g., write requests and/or read requests);
mapping module 254 for mapping logical addresses to physical addresses (e.g., using logical-to-physical mapping 270) and vice versa;
data read module 256 data for reading data, or causing data to be read, from storage device 120 (e.g., from non-volatile memory 134);
data write module 258 writing data, or causing data to be written, to storage device 120 (e.g., to non-volatile memory 134);
data erase module 260 for erasing data, or causing data to be erased, from storage device 120-1 (e.g., from non-volatile memory 134);
garbage collection module 262 for performing a garbage collection process on one or more memory devices (e.g., NVM 134-1) of storage device 120-1;
wear leveling module 264 for determining memory portions (i.e., pages or blocks) of storage device 120-1 (e.g., of NVM 134) for storing data so as to evenly wear the memory portions of storage device 120-1;
read disturb handling module 266 for one or more of: maintaining a running count of read disturbs in each zone of a plurality of non-volatile memory blocks, performing a validation operation when any read disturb count satisfies predefined threshold criteria, and initiating a data refresh when the validation operation is unsuccessful;
read prediction module 268 for predicting a read frequency for data to be stored in storage device 120-1 (e.g., in non-volatile memory 134);
mappings 270 storing one or more of: a logical-to-physical map (used, for example, by mapping module 254) that maps logical addresses recognized by the host (e.g., computer system 110) to physical addresses of storage device 120-1 (e.g., NVM devices 134), and a physical-to-logical mapping that maps physical addresses to logical addresses;
read disturb counts table 272, for storing the read disturb counts maintained by read disturb handling module 266 (e.g., to be used in predicting future read frequency for data);
read tracker table 274 for tracking number of reads for logical address spaces and/or physical address spaces (e.g., to be used in predicting future read frequency for data);
read response table 276 for storing absolute and/or relative read response times for portions (e.g., pages, layers, planes, and/or blocks) of a storage medium; and
write buffer 150 for holding and/or organizing data to be written to a storage medium (e.g., written to non-volatile memory 134).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 242 may store a subset of the modules and data structures identified above. Furthermore, memory 242 may store additional modules and data structures not described above. In some embodiments, the programs, modules, and data structures stored in memory 242, or the non-transitory computer-readable storage medium of memory 242, provide instructions for implementing at least some portions of the methods described herein. In some embodiments, some or all of these modules may be implemented with specialized hardware circuits that subsume part or all of the module functionality. In some embodiments, the above identified modules and/or programs for FIG. 2B comprise the modules and/or programs described above with respect to FIG. 2A. For example, in some embodiments, write buffer 150 comprises write buffer 140.

Although FIG. 2B shows a management module 131, FIG. 2B is intended more as functional description of the various features which may be present in a management module than as a structural schematic of the embodiments described herein. In practice, and as recognized by those of ordinary skill in the art, items shown separately could be combined and some items could be separated.

FIG. 3 is a block diagram of a read disturb counts table 230, which stores read disturb counts 302 for corresponding non-volatile memory block zones. More particularly, FIG. 3 shows that non-volatile memory 134 of storage device 120 (FIG. 1A) includes a plurality of non-volatile memory blocks 0 through B. In this example, each block in the plurality of blocks has been divided into eight zones, zone 0 through zone 7, each of which has a distinct set of word lines. In one example, each block in the plurality of blocks has 128 word lines, each of which is used to store one or more pages of data, and thus each of the eight zones of the block has 16 word lines. Each block has two edge zones, zone 0 and zone 7. Zone 0 includes word lines 0 to 15 and zone 7 includes word lines to 112 to 127. In some embodiments, read operations on word line 1 (306) and word line 126 (308), in zones 0 and 7, respectively, are known to cause a greater degree of data degradation on neighboring word lines than read operations on any of the other word lines (e.g., word lines 0, 2-125 and 127).

Furthermore, in some embodiments, read operations on the first and last word lines in each zone of a block (excluding blocks at the physical edge of a memory array in a die) are known to cause read disturb effects on data stored in neighboring word lines on both sides of those word lines. Stated another way, a read operation on a first word line at a predefined physical edge of a zone (i.e., a zone of the plurality of zones in a block of the plurality of non-volatile memory blocks) causes read disturb effects on data stored in both that zone and also in a neighboring zone. Depending on the location of the zone in the block, the neighboring zone is either in the same block, or in a neighboring block. For example, with reference to FIG. 3, when a read operation is performed on word line 310, in zone 0 of block 1, which is at the edge of block 1, zone 0 that neighbors zone 7 of block 0, the read disturb handling module increments the read disturb count 302-10 for block 1, zone 0, and also increments the read disturb count 302-07 for neighboring block 0, zone 7. In another example, when a read operation is performed on word line 304, located at the edge of block 0, zone 1 that neighbors zone 0 of block 0, the read disturb handling module increments the read disturb count 302-01 for block 1, zone 0, and also increments the read disturb count 302-00 for neighboring block 0, zone 0.

Furthermore, each block of the plurality of non-volatile memory blocks in storage device 120 has one or two neighbors, depending on the physical location of the block in an NVM die 134. For example, block 0 in FIG. 3 has only one neighbor, block 1, while block 1 has two neighbors, block 0 and block 2 (not shown). As a result, a read operation performed on an “edge word line” of a block, such as word lines 0 and 127 in the examples given above, cause the read disturb count to be incremented for both the zone containing the word line and a neighboring zone in a neighboring block, only if there is a block neighboring that edge word line. The term “edge word line” is defined herein to mean a word line at an outer edge of the non-volatile memory block in which the word line is located.

FIG. 4 is a block diagram illustrating read tracking table 400 and corresponding logical address spaces 402, in accordance with some embodiments. In some embodiments, the logical address space comprises a plurality of regions (e.g., region 402-1 through 402-M). Tracking table 400 (also sometimes called a read table or read tracker) includes read accumulators 406 for tracking the amount and/or proportion of reads from each region. In some embodiments, tracking table 400 also includes bucket IDs 404 corresponding to each region. In some embodiments, bucket identifications (IDs) 404 are used to correlate read accumulators 406 with regions 402. In some embodiments, bucket IDs 404 are used to categorize each region. In some embodiments, the data in tracking table 400 is used to rank and/or categorize the regions by read frequency (also sometimes called read temperature). As an example, an address space is divided into a plurality of equal sized regions (e.g., 1024 regions) and the regions are categorized into a plurality of buckets (e.g., 3 buckets). In this example, the regions are re-categorized after a certain number of reads (e.g., 4 billion reads).

FIGS. 5A-5B illustrate exemplar read response tables, in accordance with some embodiments. FIG. 5A shows read response table 502 with fields for media descriptions 504, read latencies 506, errors field 508, and read response ranks 510. Media descriptions 504 include a description of each region. In some embodiments, read response table 502 ranks a plurality of physical memory locations. In some embodiments, media description 504 field includes unique region IDs for each region. Read latencies 506 include a quantitative and/or qualitative latency measure for each region. In some embodiments, the latency measure is an average latency. In some embodiments, the latency measure is a maximum latency. In some embodiments, errors field 508 include a quantitative and/or qualitative error rate for each region. In some embodiments, errors field 508 includes a quantitative and/or qualitative error correction time for each region. In some instances, error rates and error correction contribute significantly to read response times (e.g., see Table 2 below). In some embodiments, the error rate is an average error rate. In some embodiments, the error rate is a maximum error rate. Read response ranks 510 include a read response rank for each region. In some embodiments, the read response rank is based on a read response time derived from the error rate and the latency.

FIG. 5A further shows regions 512 of non-volatile memory (e.g., particular regions of storage medium 132), including region 512-1 corresponding to lower pages, region 512-2 corresponding to middle pages, region 512-3 corresponding to upper pages, and region 512-4 corresponding to edge word lines (e.g., word line 0). As discussed above with reference to FIG. 3, in some instances, edge word lines cause a greater degree of data degradation and introduce more errors than any of the other word lines. Each region included in read response table 502 includes a media description 504, a read latency 506, an error rate 508, and a read response rank 510. In some embodiments, read response table 502 includes one or more additional fields not shown, such as a unique region ID field and/or a read response field with measure for each region. In some embodiments, read response table 502 includes a subset of the fields shown. For example, in some embodiments, read response table 502 includes only media description 504 and read response rank 510.

As an example, Tables 1-2 below shows quantitative latency values and error correction times for a read response table (e.g., read response table 502). The values shown in Tables 1 and 2 are prophetic values, for illustrative purposes only. Those skilled in the art will understand that latency values depend on the particular technology used in the storage device. For example, in some instances, the relative latency values between the upper, middle, and lower pages of a storage medium may be 7-9-7, while in other instances, the relative latency values may be 5-9-9.

TABLE 1
Example latency values

| Storage Medium Region | Latency Values |
|---|---|
| Upper pages | 50 μs |
| Middle pages | 70 μs |
| Lower pages | 50 μs |

TABLE 2
Example error correction times

| Error rate | Correction Time |
|---|---|
| Low | 0.5 μs |
| Medium | 1 μs |
| High | 1.25 μs |
| Very High | 20 μs |

In some embodiments, read response table 502 comprises a static table, for example populated with values determined by measurements performed on multiple memory devices of the same type as the memory devices in storage medium 132. In some embodiments, read response table 502 is informed/constructed during the production process (e.g., a memory characterization step). In some embodiments, read response table 502 is informed by memory testing and analysis, either during production or post-production. In some embodiments, read response table 502 is updated during use of storage device 120 based on measured characteristics of the storage device's storage medium, such as error rates for particular regions.

FIG. 5B shows read response table 550 in accordance with another embodiment. Read response table 550 includes fields: media descriptions 552, read latencies 554, errors 556, and read response ranks 558. FIG. 5B further shows regions 560 of non-volatile memory (e.g., particular regions of storage medium 132), including region 560-1 corresponding to a first plane described as “Plane 3,” region 560-2 corresponding to a second plane described as “Plane 2,” region 560-3 corresponding to a third plane described as “Plane 1,” and region 560-4 corresponding to a fourth plane described as “Plane 0.” In some embodiments, each plane in Planes 0-3 comprises a respective page. For example, Plane 0 comprises lower pages, Plane 1 comprises lower-middle pages, Plane 2 comprises upper-middle pages, and Plane 3 comprises upper pages. In some embodiments, each plane in Planes 0-3 corresponds to a layer of memory cells in 3D memory (e.g., 3D NAND utilizing multi-level cells (MLC). In some embodiments, the fields in FIG. 5B are populated with data as described above in reference to FIG. 5A.

FIGS. 5C-5D illustrate exemplar data organization within implementations of a write buffer, in accordance with some embodiments. FIG. 5C shows an implementation of write buffer 140 with a plurality of pages (e.g., Page 1 through Page P). FIG. 5C further shows a read response rank associated with (e.g., assigned to) each page. As shown in FIG. 5C, data 570 is received by write buffer 140 and arranged data 572 is transmitted from write buffer 140 (e.g., to storage medium 132, FIG. 1A). In some embodiments or in some circumstances, received data 570 is received from a host, such as computer 110 (FIG. 1A), as part of a host write command. In some embodiments or in some circumstances, received data 570 is received as part of a garbage collection operation within storage device 120. In some embodiments, received data 570 is received from multiple sources. For example, a portion (e.g., half) of the data is transmitted as part of a host write command and another portion (e.g., another half) of the data is received as part of a garbage collection operation. As a further example, the data transmitted as part of the host write command has associated predicted read frequencies that were determined (e.g., determined by management module 121, FIG. 1A) based on information from the host, while the data received as part of the garbage collection operation has associated predicted read frequencies that were determined based on past read frequencies, associated read disturb counts, and the like.

As another example, data 570 is received by write buffer 140. Data 570 includes a plurality of portions and each portion of data has an associated predicted read frequency. The portions of data 570 are arranged in write buffer 140 such that the portions with high predicted read frequencies are held in pages within write buffer 140 with high ranks (e.g., Rank 1), while pages with low predicted read frequencies are held in pages with low ranks (e.g., Rank 3). The arranged data 572 in write buffer 140 is then written to the storage medium (e.g., storage medium 132, FIG. 1A). The arranged data is written such that the high ranked pages in write buffer 140 correspond to pages or portions of the storage medium with good read response times and low ranked pages in write buffer 140 correspond to pages or portions of the storage medium with poor read response times. FIG. 5C shows an example with three distinct ranks. However those skilled in the art will recognize that more, or less, distinct ranks could be utilized depending on the particular situation and/or technology implementation.

In some embodiments, the predicted read frequencies associated with each portion of data are used as suggestions rather than as a directive. In some instances, write conditions and/or constraints prevent optimal data organization within write buffer 140. For example, in some circumstances write buffer 140 may be filled with multiple portions of data that each has an associated predicted read frequency that is very high. In this example, the data is arranged in write buffer 140 such that some of the data with predicted high read frequency is held in pages with low ranks (e.g., rather than wait for data with a low predicted read frequency). In some embodiments, the data arrangement in write buffer 140 is based one or more additional parameters, such as predicted write frequencies, as well as the predicted read frequency.

FIG. 5D shows an implementation of write buffer 140 with a plurality of write buffer blocks (e.g., Block 1 through Block M), where each write buffer block has an associated rank. Similar to the discussion above with respect to FIG. 5C, data is received by write buffer 140 and arranged such that write buffer blocks with high ranks are preferred for data portions with high predicted read frequencies and write buffer blocks with low ranks are preferred for data portions with low predicted read frequencies. Each write buffer block in FIG. 5D comprises a portion of memory within write buffer 140 (e.g., a page, a superpage, a RAID stripe, an erase block, or the like). As noted above, write buffer 140 is typically implemented using DRAM or NVRAM, not flash memory. Furthermore, in this context, the term “block” (i.e., as in “write buffer block”) does not mean an erase block in flash memory, and does not necessarily mean a memory portion having the size of an erase block.

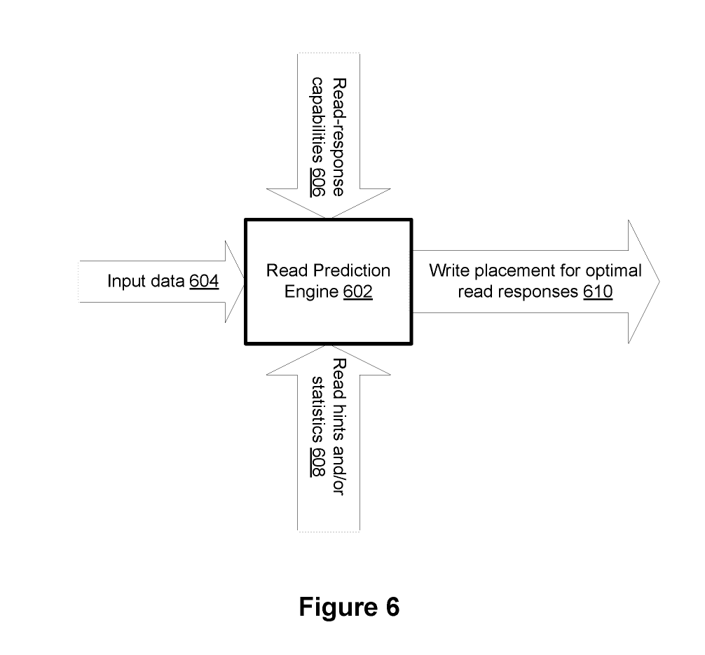

FIG. 6 is a conceptual diagram of read prediction engine 602, in accordance with some embodiments. In some embodiments, read prediction engine 602 comprises read prediction module 226 (FIG. 2A). In some embodiments, read prediction engine 602 is a component of a memory controller and/or a management module (e.g., management module 121, FIG. 1A). In some embodiments, read prediction engine 602 includes a write buffer (e.g., write buffer 140, FIG. 1A).

FIG. 6 shows read prediction engine 602 obtaining input data 604 and determining optimal write placements 610. As shown in FIG. 6, the determination is based on read-response capabilities of different storage medium regions 606 and read hints and/or read statistics 608 for input data 604. In some embodiments, input data 604 is received from a host (e.g., computer system 110, FIG. 1A). In some embodiments, input data 604 is received as part of a garbage collection operation within the storage device (e.g., storage device 120, FIG. 1A). In some embodiments, read-response capabilities 606 are obtained via a read response table, such as read response table 502 (FIG. 5A). In some embodiments, read prediction engine 602 has multiple modes, such as a first mode where average latency values are heavily weighted and a second mode where peak latency is more heavily weighted. Thus, for example, in an average latency mode read prediction engine determines that a first region is the optimal location for particular data, while in a peak latency mode read prediction engine determines that a second region is the optimal location for the particular data. In some embodiments, read hints received from a host (e.g., computer system 110, FIG. 1A) are used to predict read frequency for input data 604. In some embodiments, read statistics (e.g., past read frequency) are used to predict read frequency for input data 604. For example, data received as part of a garbage collection operation may have associated read statistics such as number of times read since the last garbage collection operations or number of read disturbs.

Read prediction engine 602 outputs write placement instructions 610 corresponding to input data 604. In some embodiments, write placement instructions 610 include a predicted read frequency for input data 604. In some embodiments, write placement instructions 610 include a preferred storage region rank for input data 604. For example, input data 604 has a high predicted read frequency and write placement instructions 610 include the preferred storage region rank as the highest available rank (e.g., Rank 1, FIG. 5A). In some embodiments, write placement instructions 610 include a particular storage region that read prediction engine 602 mapped to input data 604 (e.g., matched within a predetermined amount of variance).

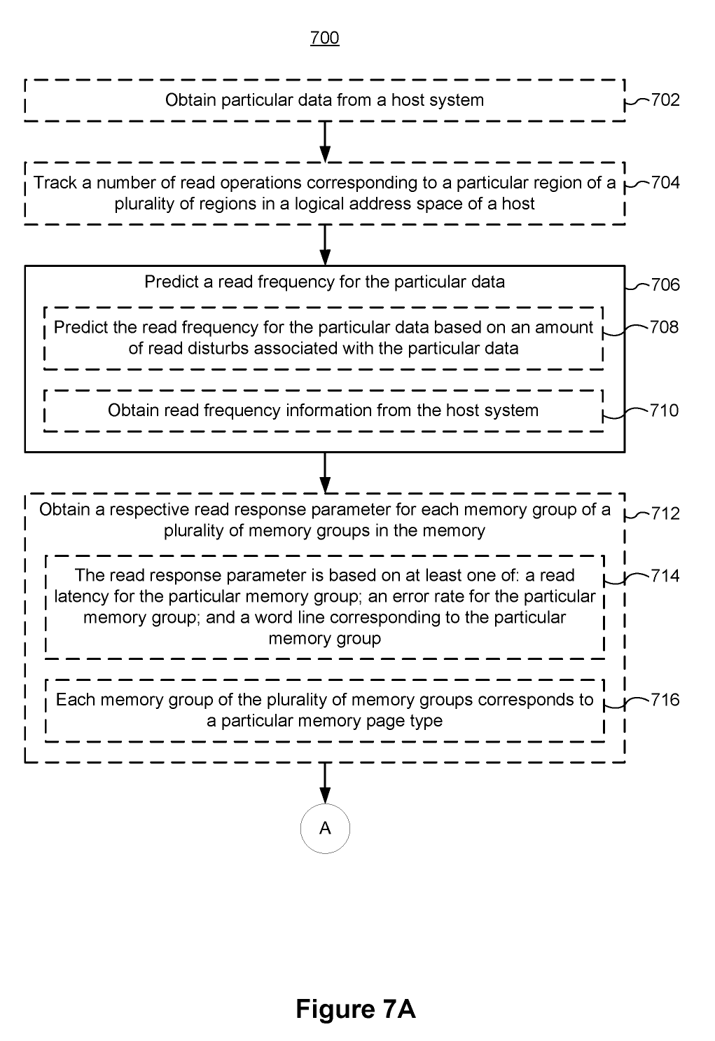

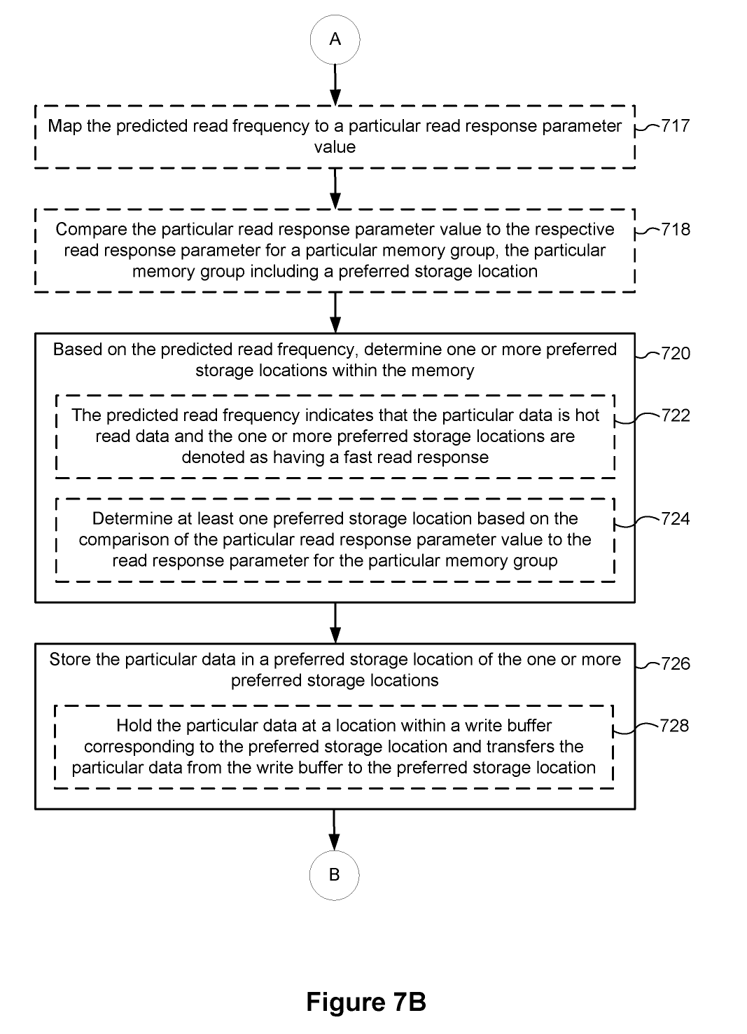

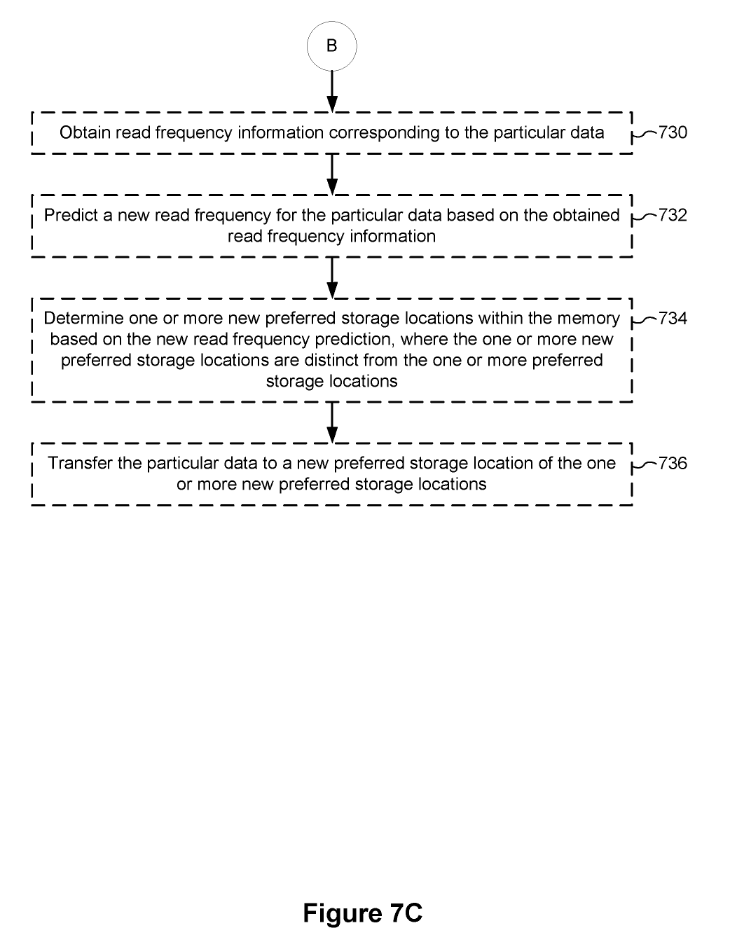

FIGS. 7A-7C illustrate a flowchart representation of read optimization method 700, in accordance with some embodiments. At least in some embodiments, method 700 is performed by a storage device (e.g., storage device 120, FIG. 1A) or one or more components of the storage device (e.g., storage controller 124 and/or storage medium 132, FIG. 1A), wherein the storage device is operatively coupled with a host system (e.g., computer system 110, FIG. 1). In some embodiments, method 700 is governed by instructions that are stored in a non-transitory computer-readable storage medium and are executed by one or more processors of a device, such as the one or more processing units 122 of management module 121, shown in FIGS. 1A and 2A. In some embodiments, method 700 is performed by a storage system (e.g., data storage system 100, FIG. 1A) or one or more components of the storage system (e.g., computer system 110 and/or storage device 120, FIG. 1A). In some embodiments, some of the operations of method 700 are performed at a host (e.g., computer system 110, FIG. 1A) and information is transmitted to a storage device (e.g., storage device 120, FIG. 1A). In some embodiments, method 700 is governed, at least in part, by instructions that are stored in a non-transitory computer-readable storage medium and that are executed by one or more processors of a host (not shown in FIG. 1A). For ease of explanation, the following describes method 700 as performed by a storage device (e.g., storage device 120, FIG. 1A). However, those skilled in the art will appreciate that in other embodiments, one or more of the operations described in method 700 are performed by a host (e.g., computer system 110, FIG. 1A).

A storage device (e.g., storage device 120, FIG. 1A) obtains (702) particular data from a host system (e.g., computer system 110, FIG. 1A). In some embodiments, the particular data is obtained from the host system as part of a host write command. In some embodiments, the particular data is obtained as part of a garbage collection process within the storage device. Using data storage system 100 in FIG. 1A as an example, the particular data is obtained by management module 121 from computer system 110 via connections 101 and host interface 129. As another example, the particular data is obtained by storage device 120 from computer system 110. In this example, the particular data is stored in storage medium 132. After the particular data is stored in storage medium 132, the particular data is obtained by management module 121 from storage medium 132 via connections 103 and storage medium interface 128.

In some embodiments, the storage device tracks (704) a number of read operations corresponding to a particular region of a plurality of regions in a logical address space of a host. In some embodiments, the number of tracked read operations is used to predict a future read frequency for data in a particular logical address space. In some embodiments, the storage device further tracks a time period for the number of tracked read operations. In some embodiments, the number of tracked read operations and the tracked time period are used to calculate a past read frequency for data in a particular logical address space. Using management module 121 in FIG. 2A as an example, the number of read operations are tracked by using read tracker table 232 in conjunction with data read module 214. In some embodiments, the storage device tracks the number of read operations using a read tracker (e.g., read tracker 400, FIG. 4). In some embodiments, the read tracker categorizes a plurality of regions in logical address space based on a relative number of read operations.

The storage device predicts (706) a read frequency for particular data. In some embodiments, the storage device predicts a relative or qualitative read frequency for the particular data (e.g., compared to other data within the storage device). In some embodiments, the storage device predicts a quantitative read frequency for the particular data. In some embodiments, the read frequency is predicted based on an analysis of bit error rates for the particular data during a garbage collection operation. In some embodiments, the analysis of bit error rates is performed by a garbage collection module (e.g., garbage collection module 220, FIG. 2A). In some embodiments, the analysis of bit error rates comprises comparing the bit error rates for the particular data with bit error rates for other data in the storage device. In some embodiments, the bit error rates for neighboring data is compared with the bit error rates for the particular data and the read frequency is predicted based on the comparison. For example, if the bit error rates for the particular data are lower than bit error rates for other data (e.g., neighboring data), then a high past read frequency is presumed, and a high future read frequency is predicted. Using management module 121 in FIG. 2A as an example, the storage device predicts the read frequency using read prediction module 226. In some embodiments, the bit error rate corresponds to one or more of: a particular page, a particular die, and a particular block of non-volatile memory.

In some embodiments, the storage device predicts (708) the read frequency for the particular data based on an amount of read disturbs associated with the particular data. For example, if data neighboring the particular data has had a high amount of read disturbs, then the past read frequency for the particular data is presumed to be high, and the future read frequency for the particular data is predicted to be high. As another example, when data is moved due to read disturbs, the storage device infers that the data has been read often and thus predicts that the data will have a high future read frequency. Using management module 121 in FIG. 2A as an example, the storage device tracks the amount of read disturbs using read disturb handling module 224 in conjunction with read disturb counts table 230. In this example, the storage device predicts the read frequency based on the amount of read disturbs using read prediction module 226 in conjunction read disturb counts table 230.

In some embodiments, the storage device obtains (710) read frequency information from the host system and predicts the read frequency for the particular data based on the obtained read frequency information. In some embodiments, the read frequency information includes historical read frequency information for the particular data. In some embodiments, the read frequency information includes a prediction by the host system as to the future read frequency of the particular data. In some embodiments, the read frequency information is obtained from the host with the particular data. In some embodiments, the read frequency information includes a flag, which when set to a predefined value (e.g., “1” or “true”) marks the particular data as hot read data, and when not set to the predefined value (e.g., when set to “0” or “false”) marks the particular data as cold read data. In some embodiments, the read frequency information is sent from the host system as metadata associated with the particular data. Using data storage system 100 in FIG. 1A as an example, storage device 120 receives read frequency information from computer system 110 via connections 101 and host interface 129. Using management module 121 in FIG. 2A as an example, storage device 120 predicts the read frequency for the particular data based on the obtained read frequency information using read prediction module 226.

In some embodiments, the storage device predicts the read frequency for the particular data based on one or more of: (1) an analysis of bit error rates associated with the particular data, (2) an amount of read disturbs associated with the particular data, (3) a tracked number of reads for the particular data, (4) other statistical analysis of the particular data, and (5) read frequency information, predictions, and/or hints received from the host system. In some embodiments, the analysis of bit error rates, amount of read disturbs, and/or number of reads is tracked at the block level (e.g., by determining a single bit error rate, read disturb count and/or number of reads for each block of a plurality of blocks in the storage device). In some embodiments, the analysis of bit error rates, amount of read disturbs, and/or number of reads is tracked at the page level (e.g., by determining a single bit error rate, read disturb count and/or number of reads for each page of a plurality of pages in the storage device). In some embodiments, the analysis of bit error rates, amount of read disturbs, and/or number of reads is tracked at the device level (e.g., by determining a single bit error rate, read disturb count and/or number of reads for each NVM device 134 of a plurality of NVM devices in the storage device).

In some embodiments, the storage device obtains (712) a respective read response parameter for each memory group of a plurality of memory groups in the memory. In some embodiments, the read response parameter comprises a read response rank for the particular memory group. Using management module 121 in FIG. 2A as an example, storage device 120 obtains the respective read response parameter for each memory group using read prediction module 226 in conjunction with read response table 234. Using read response table 502 in FIG. 5A as an example, the respective read response parameter includes read response rank 510. In some embodiments, the storage device determines the read response parameter for each memory group based on one or more metrics of the memory group, such as read latency and/or error rates.

In some embodiments, the read response parameter is based on (714) at least one of: a read latency for the particular memory group; an error rate for the particular memory group; and a word line corresponding to the particular memory group (e.g., an edge word line). In some embodiments, the read response parameter is based on the plane/layer of the particular memory group.

In some embodiments, the plurality of memory groups include one or more groups corresponding to: (1) particular pages in the memory devices of the storage device, (2) particular word lines in the memory devices of the storage device, (3) particular planes or layers in the memory devices of the storage device, (4) particular erase blocks in the memory devices of the storage device, and/or (5) particular superblocks in the memory devices of the storage device. In some embodiments, the read response parameter is based on one or more additional metrics, such as voltage levels, age, and the like. In some embodiments, the read response parameter is based on an error correction time for the particular memory group (e.g., an average error correction time). In some embodiments, the read latency for the particular memory group includes an average latency value. In some embodiments, the read latency for the particular memory group includes a peak latency value. In some embodiments, the error rate for the particular memory group is an average error rate. In some embodiments, the error rate for the particular memory group is a peak error rate. Using management module 121 in FIG. 2A as an example, storage device 120 determines the read response parameter using read prediction module 226 in conjunction with read response table 234.

In some embodiments, each memory group of the plurality of memory groups corresponds to (716) a particular memory page type. In some embodiments, each memory group in at least a subset of the plurality of memory groups corresponds to a particular memory page type. In some embodiments, the memory page types include lower pages, middle pages, and upper pages. Using read response table 502 in FIG. 5A as an example, memory groups 512-1 through 512-3 correspond to lower pages, middle pages, and upper pages respectively.

In some embodiments, the storage device maps (717) the predicted read frequency to a particular read response parameter value. For example, the storage device predicts a high read frequency for the particular data and maps that to a high read response rank 510 (FIG. 5A). Table 3 below shows an example mapping for illustrative purposes.

TABLE 3
Example Mapping

| Predicted Read Frequency | | Read Response Parameter |
|---|---|---|
| High Read Frequency | [symbol] | Fastest Read Response |
| Medium Read Frequency | [symbol] | Fast Read Response |
| Low Read Frequency | [symbol] | Medium Read Response |
| Lowest Read Frequency | [symbol] | Slow Read Response |

In some embodiments, the mapping comprises a linear mapping (e.g., as illustrated in Table 3). In some embodiments, the mapping comprises a non-linear mapping. Using management module 121 in FIG. 2A as an example, storage device 120 maps the predicted read frequency to the particular read response parameter value using mapping module 212 in conjunction with mapping(s) 228. In some embodiments, mapping(s) 228 includes a plurality of mappings for use in different situations. For example, a mapping corresponding to average read response times and a mapping corresponding to peak read response times.

In some embodiments, the storage device compares (718) the particular read response parameter value to the respective read response parameter for a particular memory group, the particular memory group including a preferred storage location. Using data storage system 100 in FIG. 1A as an example, storage device 120 compares the particular read response parameter value to a read response parameter for NVM 134-n (or for selectable portion 136 of NVM 134-n). In some embodiments, the storage device compares the particular read response parameter value to a read response parameter for a particular memory group, determines that the two parameters match (within a predetermined degree of accuracy), and thus identifies the particular memory group as a preferred storage location. As an example in reference to Table 3 above, two parameters match within a predetermined degree of accuracy if they correspond to the same read response bucket or adjacent read response buckets, such as slow read response and medium read response.

Based on the predicted read frequency, the storage device determines (720) one or more preferred storage locations within the memory. In some embodiments, the storage device determines the one or more preferred storage locations by mapping the predicted read frequency to one or more read response categories and identifying storage locations having the one or more read response categories. Using management module 121 in FIG. 2A as an example, storage device 120 determines one or more preferred storage locations using mapping module 212.

In some embodiments, the predicted read frequency indicates (722) that the particular data is hot read data and the one or more preferred storage locations are denoted as having a fast read response. In some embodiments, hot read data is data that will be (or is predicted to be) read more frequently than average read data. In some embodiments, hot read data is data that meets certain read frequency criteria. In some embodiments, data is designated as hot read data if the predicted read frequency corresponds to the highest category of relative or absolute read frequencies. In some embodiments, data is designated as hot read data if the predicted read frequency meets certain predefined criteria. In some embodiments, the particular data is designated as hot read data by the host system, and this designation is used in predicting the read frequency for the particular data. In some embodiments, the one or more preferred storage locations are denoted as being in the highest category (or one of the highest categories) of read response times. As an example in reference to Table 3 above, the predicted read frequency for the particular data is a “High Read Frequency” and the one or more preferred storage locations have the “Fastest Read Response.” As another example in reference to Table 3 above, data having a “High Read Frequency” is denoted as hot read data.

In some embodiments, the storage device determines (724) at least one preferred storage location based on the comparison of the particular read response parameter value to the read response parameter for the particular memory group. In some embodiments, determination (724) is based on comparison (718) discussed previously. Using management module 121 in FIG. 2A as an example, storage device 120 determines at least one preferred storage location using mapping module 212 in conjunction with mapping(s) 228.

The storage device stores (726) the particular data in a preferred storage location of the one or more preferred storage locations. Using data storage system 100 in FIG. 1A as an example, storage device 120 stores the particular data in storage medium 132 (e.g., in selectable portion 136 of storage medium 132) via storage medium interface 128 and connections 103. Using management module 121 in FIG. 2A as an example, storage device 120 stores the particular data in storage medium 132 using data write module 216.

In some embodiments, the storage device holds (728) the particular data at a location within a write buffer corresponding to the preferred storage location and transfers the particular data from the write buffer to the preferred storage location. Using data storage system 100 in FIG. 1A as an example, storage device 120 holds (e.g., temporarily stores) the particular data within write buffer 140. Using write buffer 140 in FIG. 5C as an example, storage device 120 holds the particular data within a particular page (e.g., page 1) within write buffer 140, the particular page having a rank corresponding to the predicted read frequency of the particular data. In some embodiments, the storage device arranges the data within the write buffer so as to enable storage of the data in a preferred storage location within the storage medium when the data is written to the storage medium.

In some embodiments, the storage device obtains (730) read frequency information corresponding to the particular data. In some embodiments, after storing the particular data in the storage medium, the storage device monitors one or more read parameters of the particular data over a period of time and stores the one or more read parameters as read frequency information corresponding to the particular data. In some embodiments, the read frequency information includes one or more of: (1) an analysis of bit error rates associated with the particular data, (2) an amount of read disturbs associated with the particular data, and (3) a tracked number of reads for the particular data. In some embodiments, the read frequency information includes read frequency information received from a host system (e.g., computer system 110, FIG. 1A). Using management module 121 in FIG. 2A as an example, storage device 120 obtains read frequency information using read prediction module 224 in conjunction with any of read disturb counts table 230, read tracker table 232, and read response table 234.

In some embodiments, the storage device predicts (732) a new read frequency for the particular data based on the obtained read frequency information. In some embodiments, the predicted new read frequency corresponds to a read frequency bucket that is distinct from the read frequency bucket corresponding to the original predicted read frequency. For example, the particular data is initially predicted as having a low read frequency and thus stored in a memory location with a slow read response parameter. New read frequency information for the particular data is analyzed and a new prediction for the particular data indicates that the particular data will have a high future read frequency. In another example, in reference to Table 3 above, the initial predicted read frequency for the particular data is a “High Read Frequency” and the new read frequency for the particular data is “Medium Read Frequency.” Using management module 121 in FIG. 2A as an example, storage device 120 predicts the new read frequency using read prediction module 224.

In some embodiments, the storage device determines (734) one or more new preferred storage locations within the memory based on the new read frequency prediction, where the one or more new preferred storage locations are distinct from the one or more preferred storage locations. In some embodiments, determination (734) is similar to determination (720) discussed above. Using management module 121 in FIG. 2A as an example, storage device 120 determines one or more new preferred storage locations using mapping module 212 in conjunction with mapping(s) 228.

In some embodiments, the storage device transfers (736) the particular data to a new preferred storage location of the one or more new preferred storage locations. Using storage device 120-1 in FIG. 1B as an example, storage device 120-1 transfers the particular data from NVM 134-1 to NVM 134-2. In some embodiments, the storage device transfers the particular data as part of a garbage collection process. In some embodiments, the storage device transfers the particular data from the initial preferred storage location to a write buffer (e.g., write buffer 150-1, FIG. 1B) and arranges the data within the write buffer so as to enable storage of the data in a new preferred storage location within the storage medium when the data is written from the write buffer to non-volatile memory. In some embodiments, the storage device transfers the particular data as part of a data retention recycling process.

In some embodiments, the storage device's memory comprises a plurality of non-volatile memory devices (e.g., NVM devices 134 and 138, FIG. 1B). In some embodiments, the non-volatile memory devices comprise flash memory devices.

In some embodiments, the storage device's memory comprises one or more three-dimensional (3D) memory devices, and where the storage device further comprises circuitry associated with operation of memory elements in one or more 3D memory devices.

In some embodiments, the storage device's circuitry and one or more memory elements in a respective 3D memory device of the one or more 3D memory devices are on the same substrate.

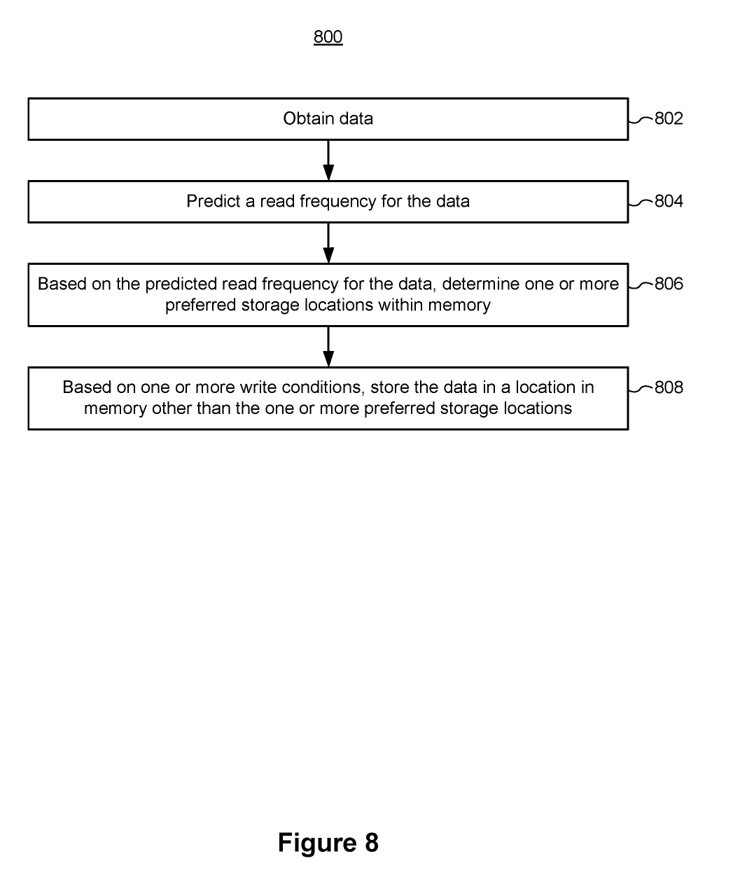

FIG. 8 illustrates a flowchart representation of read optimization method 800, in accordance with some embodiments. At least in some embodiments, method 800 is performed by a storage device (e.g., storage device 120, FIG. 1A) or one or more components of the storage device (e.g., storage controller 124, FIG. 1A), wherein the storage device is operatively coupled with a host system (e.g., computer system 110, FIG. 1). In some embodiments, method 800 is governed by instructions that are stored in a non-transitory computer-readable storage medium and are executed by one or more processors of a device, such as the one or more processing units 122 of management module 121, shown in FIGS. 1A and 2A.

In some embodiments, method 800 is performed by a storage system (e.g., data storage system 100, FIG. 1A) or one or more components of the storage system (e.g., computer system 110 and/or storage device 120, FIG. 1A). In some embodiments, some of the operations of method 800 are performed at a host (e.g., computer system 110, FIG. 1A) and information is transmitted to a storage device (e.g., storage device 120, FIG. 1A). In some embodiments, method 800 is governed, at least in part, by instructions that are stored in a non-transitory computer-readable storage medium and that are executed by one or more processors of a host (e.g., computer system 110, FIG. 1A). For ease of explanation, the following describes method 800 as performed by a storage device (e.g., storage device 120, FIG. 1A). However, those skilled in the art will appreciate that in other embodiments, one or more of the operations described in method 800 are performed by a host (e.g., computer system 110, FIG. 1A).

A storage device (e.g., storage device 120, FIG. 1A) obtains (802) data. In some embodiments, obtainment (802) is similar to obtainment (702) discussed previously. Using data storage system 100 in FIG. 1A as an example, the data is obtained by management module 121 from computer system 110 via connections 101 and host interface 129.

The storage device predicts (804) a read frequency for the data. In some embodiments, prediction (804) is similar to prediction (706) discussed previously. Using management module 121 in FIG. 2A as an example, storage device 120 predicts the read frequency using read prediction module 226.

Based on the predicted read frequency for the data, the storage device determines (806) one or more preferred storage locations within memory. In some embodiments, determination (806) is similar to determination (720) discussed previously. Using management module 121 in FIG. 2A as an example, storage device 120 determines one or more preferred storage locations using mapping module 212.

Based on one or more write conditions, the storage device stores (808) the data in a location in memory other than the one or more preferred storage locations. Using write buffer 140 in FIG. 5C as an example, the preferred storage locations for the data correspond to pages within write buffer 140 with “Rank 1.” In this example, each “Rank 1” page within write buffer 140 is filled prior to the data being received by write buffer 140. Therefore the data is held in a page having “Rank 2” and transferred to a location in non-volatile memory having a corresponding read response parameter. As another example with reference to Table 3, the data has a predicted read frequency of “High Read Frequency,” but due to one or more write conditions is stored in a memory location with a read response parameter of “Medium Read Response.” In some embodiments, the one or more write conditions include one or more of: write buffer capacity, non-volatile memory capacity, a distribution of read-response capabilities in the non-volatile memory, a write latency, and one or more write-planning parameters. In some embodiments, the predicted read frequency for the data is one of a plurality of factors use to determine where to store the data. In some embodiments, the one or more preferred storage locations are used as a suggestion for a write planning process, rather than a directive.

In some embodiments, the storage device obtains data from multiple sources prior to writing the data to non-volatile memory. For example, the storage device obtains data from multiple sources to fill a write buffer (e.g., write buffer 140, FIG. 1A) prior to transferring the data from the write buffer to non-volatile memory (e.g., storage medium 132, FIG. 1A). In some embodiments, the storage device receives a portion of the data to be written from a host system (e.g., computer system 110, FIG. 1A) and receives a second portion of the data to be written from the storage device's own storage medium, via a garbage collection process. For example, the portion of the data received from the host is predicted to have a high read frequency, and the storage medium has a particular distribution of read-response capabilities. Based on the distribution of read-response capabilities and the portion of predicted high read frequency data, the storage device “deliberately” obtains a second portion of data predicted to have a low read frequency (e.g., via garbage collection, from erase blocks known (e.g., using information in read disturb counts table 272 or read tracker table 274) to have low read frequency). In some instances, intelligently obtaining data from multiple sources enables the storage device to more consistently write data to the data's preferred locations.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible (e.g., a NOR memory array). NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration (e.g., in an x-z plane), resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device level. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

The term “three-dimensional memory device” (or 3D memory device) is herein defined to mean a memory device having multiple memory layers or multiple levels (e.g., sometimes called multiple memory device levels) of memory elements, including any of the following: a memory device having a monolithic or non-monolithic 3D memory array, some non-limiting examples of which are described above; or two or more 2D and/or 3D memory devices, packaged together to form a stacked-chip memory device, some non-limiting examples of which are described above. Additional information regarding the structure and operation of 3D memory devices is discussed in application Ser. No. 14/543,813, entitled “Method and System for Dynamic Word Line Based Configuration of a Three-Dimensional Memory Device,” which is hereby incorporated by reference in its entirety.

One of skill in the art will recognize that this invention is not limited to the two dimensional and three dimensional exemplary structures described but cover all relevant memory structures within the spirit and scope of the invention as described herein and as understood by one of skill in the art.

It will be understood that, although the terms “first,” “second,” etc. may be used herein to describe various elements, these elements should not be limited by these terms. These terms are only used to distinguish one element from another. For example, a first region could be termed a second region, and, similarly, a second region could be termed a first region, without changing the meaning of the description, so long as all occurrences of the “first region” are renamed consistently and all occurrences of the “second region” are renamed consistently. The first region and the second region are both regions, but they are not the same region. It will be further understood that the term “exemplar” as used herein means an object serving as an illustrative example, but does not mean that the object is the only example or the best example.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of optimizing read latency, comprising:
at a storage device with one or more processors and memory coupled to the one or more processors:
predicting a read frequency for particular data;
based on the predicted read frequency, determining one or more preferred storage locations within the memory; and
storing the particular data in a preferred storage location of the one or more preferred storage locations.

2. The method of claim 1, wherein predicting the read frequency for the particular data comprises predicting the read frequency for the particular data based on an amount of read disturbs associated with the particular data.

3. The method of claim 1, further comprising obtaining the particular data from a host system;
wherein predicting the read frequency for the particular data comprises obtaining read frequency information from the host system.

4. The method of claim 1, further comprising tracking a number of read operations corresponding to a particular region of a plurality of regions in a logical address space of a host;
wherein the particular data corresponds to a particular region of the plurality of regions; and
wherein predicting the read frequency for the particular data comprises predicting the read frequency for the particular data based on the tracked number of read operations.

5. The method of claim 1, wherein the predicted read frequency indicates that the particular data is hot read data; and
wherein the one or more preferred storage locations comprise storage locations denoted as having a fast read response.

6. The method of claim 1, wherein the storage device further comprises a write buffer, and wherein storing the particular data in the preferred storage location comprises:
holding the particular data at a location within the write buffer corresponding to the preferred storage location; and
transferring the particular data from the write buffer to the preferred storage location.

7. The method of claim 1, wherein the memory comprises a plurality of memory groups and the method further comprises:
obtaining a respective read response parameter for each memory group of the plurality of memory groups;
mapping the predicted read frequency to a particular read response parameter value; and
comparing the particular read response parameter value to the respective read response parameter for a particular memory group, the particular memory group including at least one preferred storage location of the one or more preferred storage locations;
wherein determining the one or more preferred storage locations within the memory includes determining the at least one preferred storage location based on the comparison of the particular read response parameter value to the read response parameter for the particular memory group.

8. The method of claim 7, wherein the read response parameter is based on at least one of:
a read latency for the particular memory group;
an error rate for the particular memory group; and
a word line corresponding to the particular memory group.

9. The method of claim 7, wherein each memory group of the plurality of memory groups corresponds to a particular memory page type.

10. The method of claim 1, further comprising:
obtaining second data;
predicting a read frequency for the second data;
based on the predicted read frequency for the second data, determining one or more second preferred storage locations within the memory; and
based on one or more write conditions, storing the second data in a location in memory other than the one or more second preferred storage locations.

11. The method of claim 1, further comprising:
obtaining read frequency information corresponding to the particular data;
predicting a new read frequency for the particular data based on the obtained read frequency information;
determining one or more new preferred storage locations within the memory based on the new read frequency prediction, wherein the one or more new preferred storage locations are distinct from the one or more preferred storage locations; and
transferring the particular data to a new preferred storage location of the one or more new preferred storage locations.

12. The method of claim 1, wherein the memory comprises a plurality of non-volatile memory devices.

13. The method of claim 1, wherein the memory comprises one or more three-dimensional (3D) memory devices, and wherein the storage device further comprises circuitry associated with operation of memory elements in one or more 3D memory devices.

14. The method of claim 13, wherein the circuitry and one or more memory elements in a respective 3D memory device of the one or more 3D memory devices are on the same substrate.

15. A storage system, comprising:
memory; and
a controller coupled to the memory, the controller configured to:
predict a read frequency for particular data;
based on the predicted read frequency, determine one or more preferred storage locations within the memory; and
store the particular data in a preferred storage location of the one or more preferred storage locations.

16. The storage system of claim 15, wherein the predicted read frequency indicates that the particular data is hot read data; and
wherein the one or more preferred storage locations comprise storage locations denoted as having a fast read response.

17. The storage system of claim 15, wherein the storage device further comprises a write buffer, and wherein storing the particular data in the preferred storage location comprises:
holding the particular data at a location within the write buffer corresponding to the preferred storage location; and
transferring the particular data from the write buffer to the preferred storage location.

18. A non-transitory computer-readable storage medium storing one or more programs for execution by one or more processors of a storage device, the one or more programs including instructions for:
predicting a read frequency for particular data;
based on the predicted read frequency, determining one or more preferred storage locations within the memory; and
storing the particular data in a preferred storage location of the one or more preferred storage locations.

19. The storage medium of claim 18, wherein the predicted read frequency indicates that the particular data is hot read data; and
wherein the one or more preferred storage locations comprise storage locations denoted as having a fast read response.

20. The storage medium of claim 18, wherein the storage device further comprises a write buffer, and wherein storing the particular data in the preferred storage location comprises:
holding the particular data at a location within the write buffer corresponding to the preferred storage location; and
transferring the particular data from the write buffer to the preferred storage location.

21. A storage device, comprising:
means for predicting a read frequency for particular data;
means for identifying one or more preferred storage locations within the memory based on the predicted read frequency; and
means for transferring the particular data to a preferred storage location of the one or more preferred storage locations.
